(19) United States
(12) Patent Application Publication
(10) Pub. No.: US 2012/0169140 A1
(43) Pub. Date: Jul. 5, 2012

(54) FORCED SHUTDOWN CIRCUIT

(75) Inventors: RONG-SHENG CAI, Shenzhen City (CN); YAN-LING GENG, Shenzhen City (CN); HUI YIN, Shenzhen City (CN); BO-CHING LIN, Tu-Cheng (TW)

(73) Assignees: HON HAI PRECISION INDUSTRY CO., LTD., Tu-Cheng (TW); HONG FU JIN PRECISION INDUSTRY (ShenZhen)CO., LTD., Shenzhen City (CN)

(21) Appl. No.: 13/175,960

(22) Filed: Jul. 5, 2011

(30) Foreign Application Priority Data
Dec. 29, 2010 (CN) 201010612225.4

(51) Int. Cl. H01H 47/00

(52) U.S. Cl. 307/112

(57) ABSTRACT

A forced shutdown circuit includes a manually operable mechanical switch, a first switch circuit including a first switch connected between a power source and a load, a central processing unit (CPU), a second switch circuit including a second switch connected to the first switch, and a delay circuit connected between the mechanical switch and the second switch circuit. When the CPU is in normal, the CPU controls the first switch to be in an “on” or “off” state allowing the power source to power or disconnected from the load according to manual operation on the mechanical switch. When the CPU is in abnormal and the manual operation on the mechanical switch reaches a preset time, the delay circuit is activated to control the second switch to be in an “on” state or in an “off” state to control the first switch to be in the “off” state.

### BACKGROUND

1. Technical Field

The present disclosure relates to shutdown circuits, and particularly, to a forced shutdown circuit used in an electronic device.

2. Description of the Related Art

When an operating system of a computer stops functioning, a mechanical power button of the computer can generate signals in response to the operations of the user to signal a central processing unit (CPU) of the computer to shut down the operating system. However, if the CPU is also in an abnormal state, a reset button may be employed to forcibly reboot the operating system. The reset button is usually arranged within a host of the computer, and a through hole is defined in the host for users to press the reset button. As the reset button is within the host, the users should use a tool to press the reset button, which may be inconvenient for the users.

Therefore, there is room for improvement within the art.

### BRIEF DESCRIPTION OF THE DRAWINGS

The components in the drawings are not necessarily drawn to scale, the emphasis instead being placed upon clearly illustrating the principles of a forced shutdown circuit. Moreover, in the drawings, like reference numerals designate corresponding parts throughout the several views.

FIG. 1 is a block diagram of a forced shutdown circuit in accordance with an exemplary embodiment.

FIG. 2 is a circuit diagram of the forced shutdown circuit of FIG. 1.

### DETAILED DESCRIPTION

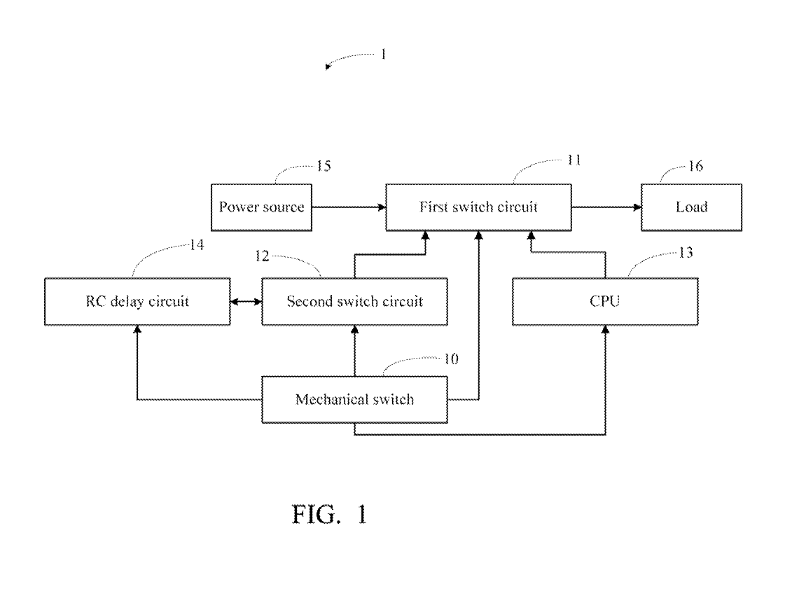

Referring to FIG. 1, a forced shutdown circuit 1 in accordance with an exemplary embodiment is illustrated. The circuit 1 can be installed in an electronic device (not shown) to shut down the operating system of the electronic device when the electronic device is in an abnormal state. The circuit 1 includes a mechanical switch 10, a first switch circuit 11, a second switch circuit 12, a central processing unit (CPU) 13, and a RC delay circuit 14. In the embodiment, the first switch circuit 11 and the second switch circuit 12 both include semiconductor elements. The mechanical switch 10 is received in the electronic device and a portion of the switch 10 is external to the electronic device for users to operate. The switch 10 can start and shut down the operating system of the electronic device. The first switch circuit 11 is connected between a power source 15 and a load 16 of the forced shutdown circuit 1, and the RC delay circuit 14 is connected between the second switch circuit 12 and the switch 10.

When the CPU is in a normal state, the CPU 13 controls the on and off of the first switch circuit 11 to control the power source 15 to power the load 16. When the CPU is in an abnormal state, a user presses the switch 10 for a preset time such as 10 seconds to activate the RC delay circuit 14. When the RC delay circuit 14 is activated, the CPU 13 turns on the second switch circuit 12 to turn off the first switch circuit 11, thus the power supply to the load 16 is cut off, an the operating system of the electronic device is enforcedly shut down. When the switch 10 is released, the second switching circuit 12 sets the RC delay circuit 14 to an initial state. Thus, the operating system of the electronic device can be restarted via pressing the mechanical switch 10.

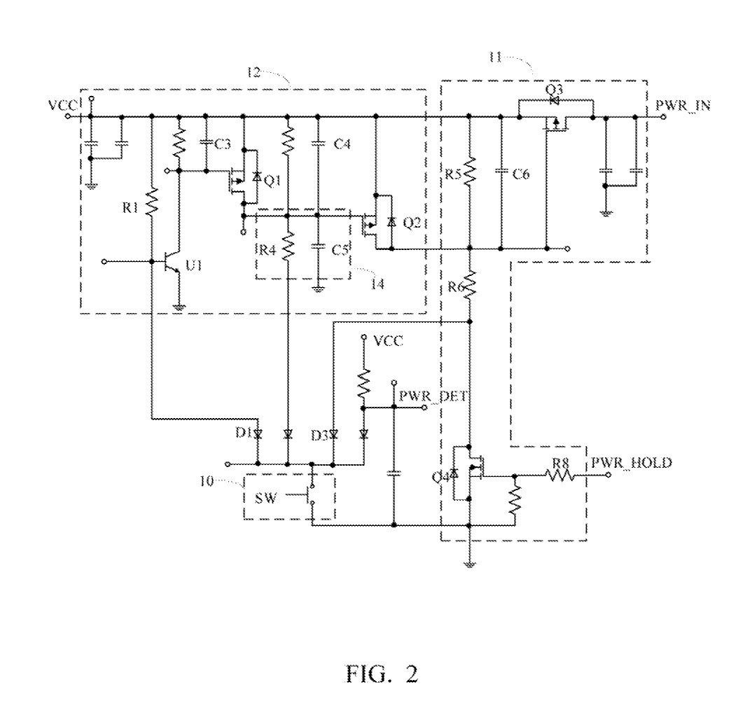

Referring to FIG. 2, a circuit diagram of the forced shutdown circuit 1 is illustrated. The CPU 13 includes a PWR_HOLD port for outputting a start control signal and a shutdown control signal, and a PWR_DET port for detecting the start control signal and the shutdown control signal. The RC delay circuit 14 includes a capacitor C5 and a resistor R4 connected to the capacitor C5. The drain of a field-effect transistor Q3 is connected to a power input (PWR_IN) port, and the gate of the field-effect transistor Q3 is connected to the drain of a field-effect transistor Q4 via a resistor R6 and further to a first end of the switch (SW) 10 via a diode D3. A second end of the SW 10 is ground. The gate of the field-effect transistors Q4 is connected to the PWR_HOLD port via a resistor R8, and then the drain is grounded. The base of a BJT (Bipolar Junction Transistor) U1 is connected to a VCC port via a resistor R1 and to the first end of the SW 10 via a diode D1, and the emitter is grounded. The drain of a field-effect transistors Q1 is connected to a capacitor C4, and the gate is connected to the collector of the BJT U1 and the capacitor C3. The gate of a field-effect transistors Q2 is connected to the capacitor C5 and the capacitor C4, the drain is connected to the drain of the field-effect transistors Q4 via the resistor R6 and to the first end of the SW further via a diode D3.

To start the operating system of the electronic device when the CPU is in the normal state, the SW 10 is pressed for a short time. When the SW 10 is pressed, the SW 10 is ground. The PWR_DET detects a low voltage level, and the CPU 13 controls the PWR_HOLD port to generate a high voltage level to turn on the field-effect transistor Q4. After the field-effect transistor Q4 is turned on, a voltage drop is generated between the source and the gate of the field-effect transistor Q3, and the field-effect transistor Q3 is correspondingly turned on. Thus, the operating system is started.

To shut down the operating system of the electronic device when the CPU is in the normal state, the SW 10 is pressed again for a short time. When the SW 10 is pressed, the SW 10 is grounded. The PWR_DET detects a low voltage level, and the CPU 13 controls the PWR_HOLD port to generate a low voltage level to turn off the field-effect transistor Q4, and the field-effect transistor Q3 is correspondingly turned off. Thus, the operating system is shut down.

To shut down the operating system of the electronic device when the CPU is in the abnormal state, the SW 10 is pressed for the preset time. The preset time is longer than the short time. When the SW 10 is pressed, the SW 10 is ground for the preset time, thus the voltage of the base of the BJT U1 becomes low, and the BJT U1 is turned off. The voltage of the gate of the field-effect transistor Q1 becomes high, and the field-effect transistor Q1 is correspondingly turned off. Thus, when the capacitor C5 of the RC delay circuit 14 discharges continuously for the preset time, it causes the voltage of the gate of the field-effect transistor Q2 to become low allowing the field effect transistor Q2 to turn on. A voltage difference between the source and the gate of the field-effect transistor Q3 decreases as the field-effect transistor Q2 is turned on, thus the field-effect transistor Q3 is correspondingly turned off. Therefore, the operating system is enforcedly shut down.

To restart the operating system of the electronic device when the operating system is enforcedly shut down, the SW 10 is released, thus the voltage of the base of the BJT U1 becomes high, and the BJT U1 is turned on. The gate of the field-effect transistor Q1 is ground via the turned-on BJT U1, and the field-effect transistor Q1 is correspondingly turned on. Thus, the capacitor C5 is charged by the VCC via the turned-on field-effect transistor Q1, causing the voltage of the gate of the field-effect transistor Q2 to become high and turn off the field-effect transistor Q2. Therefore, the operating system can be restarted via pressing the SW 10 for a short time.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A forced shutdown circuit comprising:
a manually operable mechanical switch;
a first switch circuit comprising a first switch configured to be connected between a power source and a load, the first switch configured for selectively switching between an “on” state where the power source is allowed to power the load and an “off” state where the power source is disconnected from the load;
a central processing unit (CPU) having a normal state and an abnormal state, wherein when the CPU is in a normal state, the CPU controls the first switch to selectively work in the “on” state or the “off” state according to manual operation acted upon the mechanical switch;
a second switch circuit comprising a second switch connected to the first switch, the second switch having an “on” state and an “off” state to respectively control the first switch to be in the “on” state or in the “off” state; and
a delay circuit connected between the mechanical switch and the second switch circuit, the delay circuit being configured for being activated by the mechanical switch when the CPU is in the abnormal state and the manual operation acted upon the mechanical switch reaches a preset time, the activation of the delay circuit controlling the second switch circuit to be in the “on” state or in the “off” state to control the first switch to be in the “off” state.

2. The forced shutdown circuit as recited in claim 1, wherein the delay circuit comprises a capacitor and a first resistor connected to the capacitor, and the capacitor is grounded.

3. The forced shutdown circuit as recited in claim 1, wherein the first switching circuit further comprises a third switch, the first switch is connected to one end of the third switch and the mechanical switch, and the other end of the third switch is grounded, the CPU is configured to control the third switch to be selectively on or off to allow the first switch to be on or off accordingly; and the second switching circuit further comprises a fourth switch and a fifth switch, a control end of the fifth switch is connected to one end of the fourth switch, and the other end of the fourth switch is connected to the delay circuit, and the second switch is connected to the third switch and the mechanical switch, the manual operation acted upon the mechanical switch makes the fifth switch to be on or off, to allow the fourth switch to control the second switch to be on or off accordingly.

4. The forced shutdown circuit as recited in claim 3, wherein the first switch, the second switch, the third switch, and the fourth switch are field effect transistors.

5. The forced shutdown circuit as recited in claim 3, wherein the fifth switch is a bipolar junction transistor.
